(19) United States
(12) Patent Application Publication
(10) Pub. No.: US 2013/0286068 A1
(43) Pub. Date: Oct. 31, 2013

(54) LIQUID EJECTING APPARATUS AND CONTROLLING METHOD THEREOF

(71) Applicant: SEIKO EPSON CORPORATION, Tokyo (JP)

(72) Inventors: Shinichi ITAYA, Matsumoto (JP); Maki NARIAI, Shiojiri (JP); Kinya OZAWA, Shiojiri (JP); Akihito SAO, Matsumoto (JP)

(73) Assignee: Seiko Epson Corporation, Tokyo (JP)

(21) Appl. No.: 13/851,398

(22) Filed: Mar. 27, 2013

(30) Foreign Application Priority Data
Apr. 27, 2012 (JP) 2012-102531

(51) Int. Cl. B41J 2/07

(52) U.S. Cl. CPC B41J 2/07
USPC 347/9

(57) ABSTRACT

A liquid ejecting apparatus that includes a liquid ejecting head capable of ejecting a liquid containing solid contents from a nozzle, by driving pressure generating unit for changing a capacity of a pressure chamber communicating with the nozzle; and control unit for controlling the drive of the pressure generating unit, wherein the control unit drives the pressure generating unit so that a volume of the liquid ejected from the nozzle per a unit time is equal to or less than 60 nl/s, and an initial speed of the liquid ejected from the nozzle is equal to or less than 8 m/s.

The entire disclosure of Japanese Patent Application No. 2012-102531, filed Apr. 27, 2012 is expressly incorporated by reference herein.

### BACKGROUND

1. Technical Field

The present invention relates to a liquid ejecting apparatus that ejects liquid from a nozzle, particularly, liquid containing solid contents such as pigments, and a method of controlling the liquid ejecting apparatus.

2. Related Art

The liquid ejecting apparatus is an apparatus that includes a liquid ejecting head capable of ejecting the liquid as liquid droplet from the nozzle, and ejects various liquids from the liquid ejecting head. As a typical liquid ejecting apparatus, for example, there is an image recording apparatus such as an ink jet type recording apparatus (a printer) that includes an ink jet type recording head (hereinafter, referred to as a recording head), and ejects the liquid ink from the nozzle of the recording head as the ink droplet to perform recording. Furthermore, the liquid ejecting apparatus is used for ejecting various types of liquids, such as a color material used for a color filter such as a liquid crystal display, an organic material used for an organic EL (Electro Luminescence) display, and an electrode material used for forming an electrode. Moreover, a recording head for an image recording apparatus ejects the liquid ink, and a color material ejecting head for a display manufacturing apparatus ejects solution of each color material such as R (Red), G (Green), and B (Blue). Furthermore, an electrode material ejecting head for an electrode forming apparatus ejects a liquid electrode material, and a biogenic organic matter ejecting head for a chip manufacturing apparatus ejects a solution of the biogenic organic matter.

The recording head mounted on the above-mentioned printer includes pressure generating unit such as a piezoelectric element that causes a pressure fluctuation in the liquid in a pressure chamber communicating with the nozzle, and a heating element. The recording head is configured so as to eject the liquid in the pressure chamber from the nozzle as a liquid droplet, using the pressure fluctuation due to the pressure generating unit. Moreover, in the liquids ejected from the recording head, there is a liquid that contains particles in a solvent. For example, there is a metallic ink in which a metallic piece formed of tubular aluminum or the like is dispersed in the ink solvent (for example, JP-A-2011-149028).

Herein, an opening diameter of the nozzle opened to the pressure chamber is smaller than a cross-sectional area of the pressure chamber. For this reason, in a boundary portion between the pressure chamber and the nozzle, the cross-sectional area of a flow path suddenly changes. In regard to the flow of the liquid in the boundary portion, in a portion deviating from the nozzle, the turbulence and retention of the liquid occur. Furthermore, since the supply of the liquid to the pressure chamber is performed via a liquid supply path that is set to be smaller than the cross-sectional area of the pressure chamber, the same phenomenon can also occur in the boundary portion between the liquid supply path and the pressure chamber. Due to the stay and the turbulence of the liquid, when ejecting the liquid from the nozzle, there was a concern that the flow of the liquid toward the pressure chamber from the liquid supply path, and toward the nozzle from the pressure chamber may be disturbed. Thereby, for example, when continuously ejecting the liquid from the same nozzle, there is a concern that the ejecting characteristics (an amount, a flight direction, a flight speed or the like of the liquid droplet) of the liquid of each time fluctuate and are not matched, and there was a concern that the recording quality to a recording medium (an impact target) may decline. Moreover, the influence of the stay and the turbulence of the liquid become larger, particularly when ejecting the liquid that contains the solid contents such the tubular particles used for a metallic ink or the like.

### SUMMARY

An advantage of some aspects of the invention is to provide a liquid ejecting apparatus capable of stably ejecting the liquid containing the solid contents, and a method of controlling the liquid ejecting apparatus.

According to an aspect of the invention, there is provided a liquid ejecting apparatus that includes a liquid ejecting head capable of ejecting a liquid containing solid contents from a nozzle, by driving pressure generating unit for changing a capacity of a pressure chamber communicating with the nozzle; and control unit for controlling driving of the pressure generating unit, wherein the control unit drives the pressure generating unit so that the volume of the liquid ejected from the nozzle per a unit time is equal to or less than 60 nl/s, and an initial speed of the liquid ejected from the nozzle is equal to or less than 8 m/s.

In this case, when continuously ejecting the liquid, the liquid electing characteristics of each time can be matched, and thus the liquid can be stably ejected. Thereby, the recording quality of the recording medium can be improved.

Furthermore, in the above-mentioned configuration, it is preferable that the control unit set a driving frequency of the pressure generating unit so that the volume of the liquid ejected from the nozzle per a unit time is equal to or less than 60 nl/s, and the control unit drive the pressure generating unit, using the driving voltage that is set so that the initial speed of the liquid ejected from the nozzle is equal to or less than 8 m/s.

In this case, the stable ejection of the liquid can be easily performed.

Moreover, according to another aspect of the invention, there is provided a method of controlling a liquid ejecting apparatus that includes a liquid ejecting head capable of ejecting a liquid containing solid contents from a nozzle, by driving pressure generating unit for changing a capacity of a pressure chamber communicating with the nozzle, the method includes driving the pressure generating unit so that a volume of the liquid ejected from the nozzle per a unit time is equal to or less than 60 nl/s and an initial speed of the liquid ejected from the nozzle is equal to or less than 8 m/s.

### BRIEF DESCRIPTION OF THE DRAWINGS

The invention will be described with reference to the accompanying drawings, wherein like numbers reference like elements.

FIG. 1 is a perspective view that describes a configuration of a printer.

FIG. 2 is a cross-sectional view of a recording head.

FIG. 3 is an enlarged cross-sectional view taken from line III-III in FIG. 2.

FIG. 4 is a block diagram that describes an electrical configuration of the printer.

FIG. 5 is a wave from view that describes a configuration of an ejection drive pulse.

FIG. 6 is a diagram that shows a correlation between a discharge quantity of ink per unit time and discharge stability.

FIG. 7 is a graph that shows a correlation between a flight speed of the ink ejected from the nozzle and the number of a bad discharge nozzle.

### DESCRIPTION OF EXEMPLARY EMBODIMENTS

Hereinafter, an embodiment of the invention will be described with reference to the attached drawings. In addition, in the embodiment described below, although various limitations are made as a preferable specific example of the invention, the scope of the invention is not limited to such an aspect, particularly unless stated the invention is not limited to the following description. Furthermore, the following description will be made by the use of an ink jet type printer 1 (a type of a liquid ejecting apparatus) as the liquid ejecting apparatus of the invention as an example. In addition, as the ink ejected (discharged) from the printer 1 of the present embodiment, for example, a metallic ink containing a metallic piece formed of aluminum having a particle diameter of 0.5 to 3.0 μm is used.

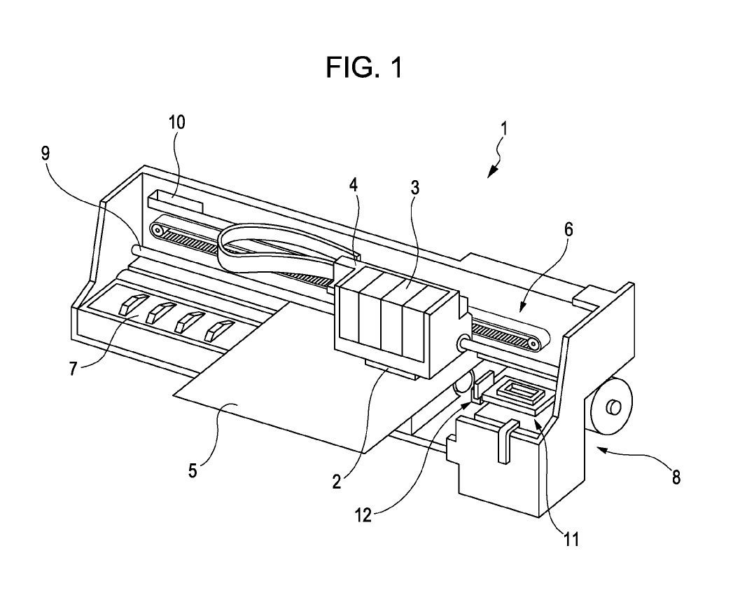

FIG. 1 is a perspective view that shows a configuration of the printer 1. The printer 1 includes a carriage 4 to which an ink jet type recording head 2 (hereinafter, a recording head) as a type of a liquid ejecting head is attached, and to which an ink cartridge 3 as a type of a liquid storage member with the ink stored therein is attached in an attachable and detachable manner. In the rear portion of the carriage 4, a carriage movement mechanism 6 is included which moves the carriage 4 back and forth in a paper width direction of a recording paper 5 (a recording medium or a type of an impact target), that is, a main scanning direction. Furthermore, a platen 7 is included below the recording head 2 in the recording operation at an interval. On the platen 7, the recording paper 5 is transported in a sub scanning direction perpendicular to the main scanning direction, by a transport mechanism 8 provided behind the printer 1.

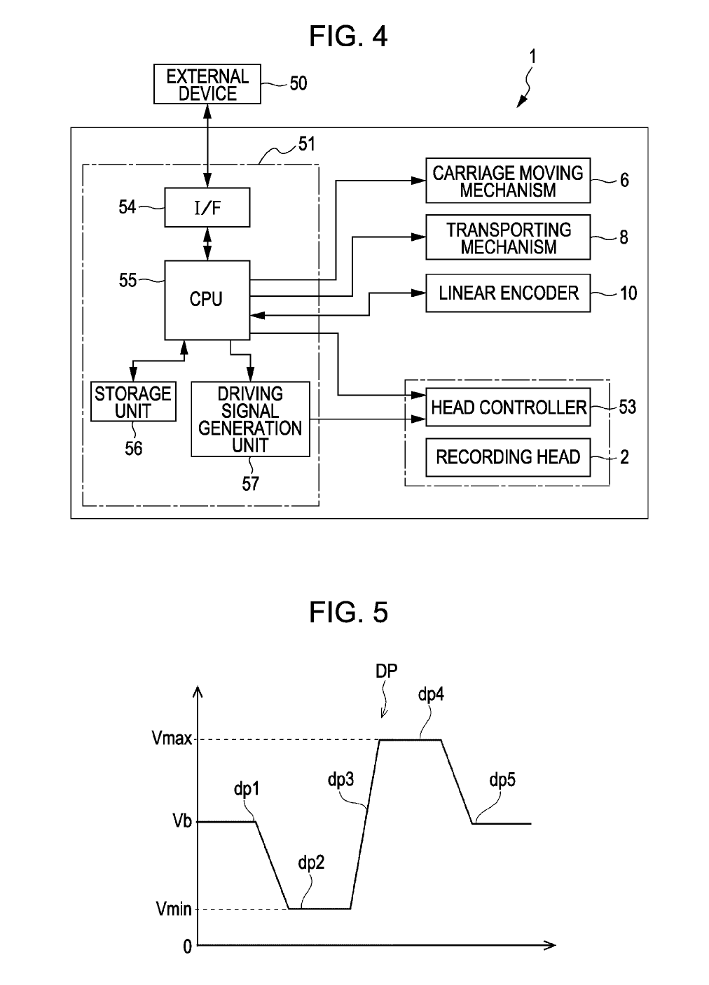

The carriage 4 is attached to a guide rod 9 constructed in the main scanning direction in a pivoted state, and moves in the main scanning direction along the guide rod 9 by the operation of the carriage movement mechanism 6. The position of the carriage 4 in the main scanning direction is detected by a linear encoder 10 that is a type of position information detecting unit. The linear encoder 10 transmits the detection signal thereof, that is, the encoder pulse (a type of position information) to a control unit 51 (see FIG. 4) of the printer 1.

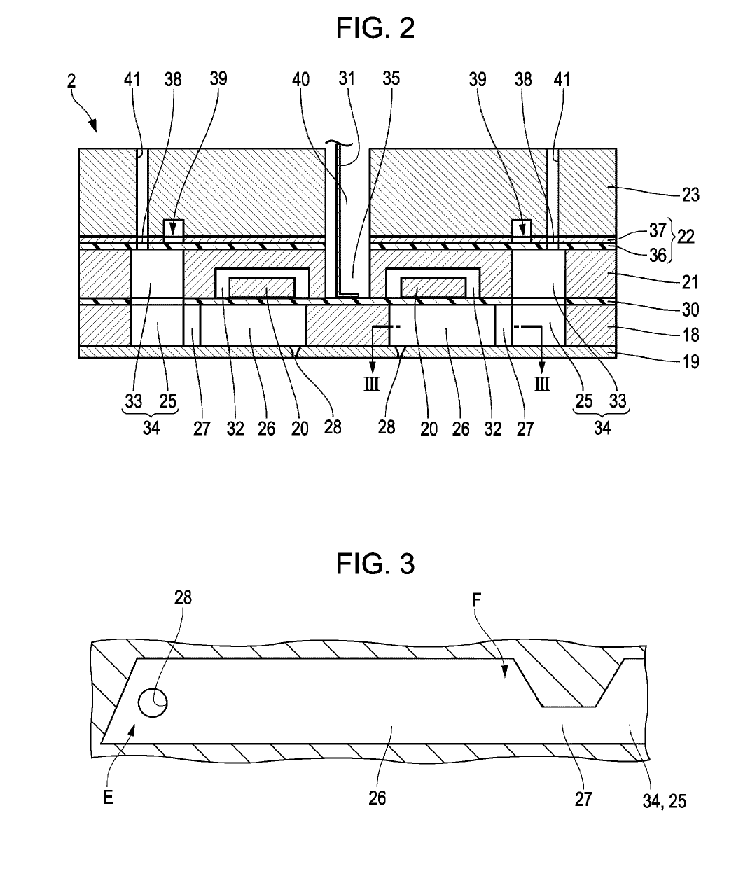

Furthermore, in an outer end portion region of a recording region within the movement range of the carriage 4, a home position serving as a basic point of scanning of the carriage 4 is set. At the home position in the present embodiment, a capping member 11 configured to seal a nozzle surface (a nozzle plate 19: see FIG. 2) of the recording head 2, and a wiper member 12 for wiping the nozzle surface are placed. Moreover, the printer 1 performs a so-called bidirectional recording that records characters, images or the like on the recording paper 5, in both directions of an outward movement in which the carriage 4 moves from the home position toward an end portion of an opposite side and an inward movement in which the carriage 4 returns from the end portion of the opposite side to the home position side.

Next, the recording head 2 will be described.

As shown in FIG. 2, the recording head 2 includes a flow path substrate 18, a nozzle plate 19, a piezoelectric element 20 (a type of pressure generating unit), a protective substrate 21, a compliance substrate 22, and a head case 23.

The flow path substrate 18 is constituted by a silicon single crystalline substrate that is long along a nozzle row direction, and is formed with two thin communication portions 25 along the same direction. In a region interposed between the communication portions 25, total two rows of a plurality of pressure chambers 26 are formed for each communication portion 25 in a state of being arranged in the nozzle row direction. Each of the pressure chambers 26 communicates with the communication portion 25 via a liquid supply path 27 that is formed to be narrower even than the pressure chambers 26.

On a lower surface (a surface of an opposite side to the piezoelectric element 20) of the flow path substrate 18, the nozzle plate 19 is adhered via an adhesive, a thermal welding film or the like. The nozzle plate 19 is formed by SUS (stainless steel), silicon single crystalline or the like, and a plurality of nozzles 28 is drilled which communicate to the liquid supply path 27 of each pressure chamber 26 on the opposite side. The nozzles 28 of the present embodiment are arranged at a pitch of 360 dpi along the main scanning direction. Furthermore, the nozzle rows constituted by the nozzles 28 are formed in two rows in response to each pressure chamber 26.

On an upper surface (a surface of an opposite side to the nozzle plate 19) of the flow path substrate 18, an elastic film 30 is stacked. On the elastic film 30, for example, piezoelectric elements 20, on which a lower electrode film, a piezoelectric layer and an upper electrode film are sequentially stacked, are arranged in two rows in a state of facing each pressure chamber 26. One end of a lead electrode (not shown) conducting with the upper electrode film is connected to one (a central side) end portion of the piezoelectric element 20. The other end of the lead electrode extends to the central portion side of the recording head 2 on an insulator film, and is electrically connected to one end of a flexible cable 31. In addition, the other end of the flexible cable 31 is connected to a control unit 51.

Furthermore, on the elastic film 30, in a region facing the piezoelectric element 20, a protective substrate 21 having a piezoelectric element holding space 32 serving as a space of a size which does not hinder the displacement thereof is joined. In the protective substrate 21, at the position facing the communication portion 25, two long reservoir portions 33 penetrating in a thickness direction are provided, and a placement space 35 capable of connecting the flexible cable 31 with the lead electrode is placed in the central portion. In addition, the reservoir portion 33 communicates with each communication portion 25, and constitutes a reservoir (a common liquid chamber) 34 that supplies the pressure chamber 26 with the ink.

A compliance substrate 22 is a substrate in which a sealing film 36 having flexibility and a fixing substrate 37 formed of a hard member such as a metal are stacked, and is joined to the upside (an opposite side to the flow path substrate 18) of the protective substrate 21. In the compliance substrate 22, a liquid introduction port 38 configured to introduce the ink into the reservoir 34 is formed to penetrate in the thickness direction. Furthermore, a region other than the liquid introduction portion 38 of a region of the compliance substrate 22 facing the reservoir 34 is a sealing portion 39 that is constituted only by the sealing film 36 from which the fixing substrate 37 is removed. Thereby, the reservoir 34 is sealed by the sealing portion 39 having flexibility, and thus the compliance is obtained.

The head case 23 is a hollow box-like member that is joined to the upside (an opposite side to the protective substrate 21) of the compliance substrate 22. An insertion space 40 communicating with the placement space 35 of the protective substrate 21 and a case flow path 41 are formed inside the head case 23 so as to penetrate in the height direction. The flexible cable 31 is inserted into the insertion space 40. The case flow path 41 is a flow path for supplying the reservoir 34 with the ink from the ink cartridge 3, and a lower end thereof communicates with the liquid introduction port 38. Furthermore, in a portion of the lower surface of the head case 23 facing the sealing portion 39, a sealing space that does not inhibit the flexible deformation of the sealing film 36 is included.

The recording head 2 configured in this manner takes the ink from the ink cartridge 3 into the pressure chamber 26 via the case flow path 41, the reservoir 34, and the liquid supply path 27. Moreover, the recording head 2 causes the pressure fluctuation in the ink in the pressure chamber 26 by driving the piezoelectric element 20, and ejects the ink from the nozzles 28 using the pressure fluctuation.

The tubular particles contained in the ink of the present embodiment will be described below.

The tubular particles related to the present embodiment are particles in which a ball conversion 50% average particle diameter (d50) depending on a light scattering method is 0.5 to 3 μm.

“Tubular particles” refer to particles that have a substantially flat surface (an X-Y plane) and have a substantially uniform thickness (Z). For example, since the tubular particles are manufactured by crushing a metal deposition film, it is possible to obtain metal particles that have a substantially flat surface and a substantially uniform thickness. Thus, it is possible to define a long diameter on a plane of the tubular particles to X, a short diameter thereof to Y, and a thickness thereof to Z. In addition, the substantially flat surface unit that a surface in which a projection area of the tubular particles is maximum.

The ball conversion 50% average particle diameter (d50) depending on the light scattering method is a value that is obtained as below. That is, the particles in the disperse medium are irradiated with light, and the generated diffractive scattering light is measured by directors placed on the front, the side and the rear of the disperse medium. The article that is an originally indeterminate form is supposed to a spherical form using the measured value, an accumulation curve is obtained by setting the total volume of the particle group converted to the circle having the same volume as the particle to 100%, and a point, in which the accumulation value becomes 50% of that time, is referred to as the “ball conversion 50% average particle diameter (d50) depending on the light scattering method”. As a measuring device, for example, there is a laser diffractive scattering type particle size distribution measurer LMS-2000e (manufactured by Say Shin Company Co., Ltd.) or the like. Since the ball conversion 50% average particle diameter (d50) depending on the light scattering method is within the above-mentioned range, a coating film having high photoluminescent can be formed on a record target, and discharge stability of the ink from the nozzles also rises.

Next, an electrical configuration of the printer 1 will be described. FIG. 4 is a block diagram that shows an electrical configuration of the printer 1. The printer 1 in the present embodiment has the carriage movement mechanism 6, the transport mechanism 8, the linear encoder 10, the recording head 2 and the control unit 51. In addition, an external device 50 is, for example, an electronic apparatus that handles the images of a computer, a digital camera or the like. The external device 50 is connected to the control unit 51 of the printer 1 in a transmissible manner, and transmits the print data depending on the images or the like to the printer 1 so as to print images and texts on the recording medium such as a the printer 5 in the printer 1.

The control unit 51 is a control unit for controlling each portion of the printer 1, and has an interface (I/F) unit 54, a CPU 55, a storage unit 56, and a drive signal generation unit 57. The interface unit 54 performs the transmission and reception of data for the printer 1, for example, receives the print data and the print command transmitted to the printer 1 from the external device 50, and transmits the state information of the printer 1 to the external device 50. The CPU 55 is an arithmetic processing device for controlling the whole printer 1. The storage unit 56 is an element that stores the program of the CPU 55 and the data used for various types of control, and includes a ROM, a RAM, and an NVRAM (nonvolatile storage element). Moreover, the CPU 55 controls each unit depending on the program stored in the storage unit 56.

Furthermore, the CPU 55 functions as timing pulse generating unit for generating the timing pulse from an encoder pulse that is output from the linear encoder 10. Moreover, the CPU 55 controls the transmission of the print data, the generation of the drive signal using the drive signal generation unit 57 or the like in synchronization with the timing pulse. In addition, the CPU 55 generates the timing signal such as a latch signal and a change signal based on the timing pulse, and outputs the signal to the head control unit 53 of the recording head 2. The latch signal is a signal that regulates the generation period of the drive signal, and is also a signal that regulates the application timing of the drive pulse initially generated in the drive signal to the piezoelectric element 20. The change signal is a signal in which a change pulse is generated at a predetermined interval after the latch signal, and is a signal that regulates the application timing of the drive pulse included in the drive signal to the piezoelectric element 20.

The head control unit 53 performs the application control or the like of the drive signal of the recording head 2 to the piezoelectric element 20, based on the head control signal (the timing signal or the like) from the control unit 51. In the invention, the application control of the drive signal to the piezoelectric element 20 is performed so that the volume of the ink ejected from the nozzles 28 per a unit time is equal to or less than 60 nl/s. In addition, the control unit 51 and the head control unit 53 correspond to the control unit in the invention.

The drive signal generation unit 57 generates an analog voltage signal, based on the waveform data concerning the waveform of the drive signal. Furthermore, the drive signal generation unit 57 amplifies the voltage signal to generate the drive signal. In the invention, the drive signal is generated in which the initial speed of the ink ejected from the nozzles 28 is equal to or less than 8 m/s.

Herein, the drive signal is a series of signals that includes at least one ejection drive pulse DP or more within a unit period serving as a generation repetition period of the drive signal. Furthermore, the ejection drive pulse DP is a type of drive voltage that causes the piezoelectric element 20 to perform a predetermined operation, in order to perform the recording operation that ejects the ink from the nozzles 28 of the recording head 2.

FIG. 5 is a waveform diagram that shows an example of a configuration of the ejection drive pulse DP included in the drive signal at the time of the recording operation. In addition, in FIG. 5, a vertical axis is an electric potential, and a horizontal axis is a time. Furthermore, as shown in FIG. 5, the ejection drive pulse DP of the present embodiment has positive polarity on the average.

The ejection drive pulse DP includes an expansion element dp1, an expansion maintenance element dp2, a contraction element dp3, a contraction maintenance (damping hold) element dp4, and a return element dp5. The expansion element dpi is configured so that an electric potential changes from a standard electric potential (an intermediate electric potential) Vb to a minimum electric potential (a minimum voltage) Vmin to a negative side to expand the pressure chamber 26. The expansion maintenance element dp2 maintains the minimum electric potential Vmin for a fixed time. The contraction element dp3 is configured so that an electric potential changes from the minimum electric potential Vmin to a maximum electric potential (a maximum voltage) Vmax to a positive side to suddenly contract the pressure chamber 26. The contraction maintenance element dp4 maintains the maximum electric potential Vmax for a fixed time. The return element dp5 returns the electric potential from the maximum electric potential Vmax to the standard electric potential Vb.

When the ejection drive pulse DP is applied to the piezoelectric element 20, it acts as follows. First, the piezoelectric element 20 contracts by the expansion element dpi, and thus, the pressure chamber 26 expands from the standard capacity corresponding to the standard electric potential Vb to the maximum capacity corresponding to the minimum electric potential Vmin. Thereby, the meniscus exposed to the nozzles 28 is drawn into the pressure chamber 26 side. The expansion state of the pressure chamber 26 is constantly maintained during application period to the expansion maintenance element dp2. When the contraction element dp3 is applied to the piezoelectric element 20 after the expansion maintenance element dp2, the piezoelectric element 20 extends, thereby the pressure chamber 26 suddenly contracts from the maximum capacity to the minimum capacity corresponding to the maximum electric potential Vmax. The ink in the pressure chamber 26 is pressed due to the sudden contraction of the pressure chamber 26, thereby the ink of several pl to tens of pl is ejected from the nozzles 28. The contraction state of the pressure chamber 26 is maintained for a short time over the application period of the contraction maintenance element dp4, then the damping element dp5 is applied to the piezoelectric element 20, and the pressure chamber 26 returns to the standard capacity corresponding to the standard electric potential Vb from the capacity corresponding to the maximum electric potential Vmax.

However, when continuously applying the ejection drive pulse DP to the piezoelectric element 20, it is confirmed that the ejection characteristics (the amount, the flight direction, and the flight speed or the like of the ink droplet) of the ink ejected from the nozzles 28 gradually change. This is because an opening diameter of the nozzle 28 is smaller than a cross-sectional area of the pressure chamber 26, a cross-sectional area of a flow path in a boundary portion between the pressure chamber 26 and the nozzle 28 suddenly changes, and thus the stay and the turbulence of the ink occur in an opening edge E (see FIG. 3) of the nozzle 28. Furthermore, since the cross-sectional area of the flow path also suddenly changes in the boundary portion between the liquid supply path 27 and the pressure chamber 26, the stay and the turbulence of the ink can also occur in a region F (see FIG. 3) in the pressure chamber 26 deviating from the liquid supply path 27. Moreover, due to the stay and the turbulence of the ink, the flow of the ink toward the nozzle 28 from the liquid supply path 27 via the pressure chamber 26 is disturbed, and the ejection characteristics of the ink change. Particularly, when ejecting the ink containing the solid contents such as the tubular particles used for the metallic ink or the like, and when the flow of the ink is violent, that is, when continuously ejecting the liquid from the nozzle 28, the influence to the ejection characteristics of the ink due to the stay and the turbulence of the ink becomes remarkable.

In order to prevent the change of the ejection characteristics, the printer 1 of the invention is set so that, by controlling the voltage waveform of the ejection drive pulse DP and the application timing to the piezoelectric element 20 of the ejection drive pulse DP, the volume of the ink ejected from one nozzle 28 per a unit time is equal to or less than 60 nl/s and the initial speed of the ink ejected from the nozzle 28 is equal to or less than 8 m/s. The volume of the ink ejected from one nozzle 28 per a unit time can be arbitrarily set, mainly by adjusting the drive frequency of the piezoelectric element 20. The drive frequency of the piezoelectric element 20 can be adjusted, by changing the generation period of the drive signal. Furthermore, the initial speed of the ink ejected from the nozzle 28 can be adjusted by a slope (an electric potential gradient) of an electric potential change element (particularly, an electric potential change element concerning the ejection of the ink) of the ejection drive pulse DP, and the application timing of the electric potential change element to the piezoelectric element. Generally, by making the slope of the electric potential change element of the ejection drive pulse DP to be steep, the initial speed of the ink increases, and by making the slope of the electric potential change element of the ejection drive pulse DP to be gentle, the initial speed of the ink decreases. Furthermore, by adjusting the application timing of the electric potential change element to the piezoelectric element, the initial speed of the ink can also be increased or decreased, using the vibration of the meniscus of the nozzles.

In this manner, a basis of controlling the drive signal of the piezoelectric element 20 will be described below.

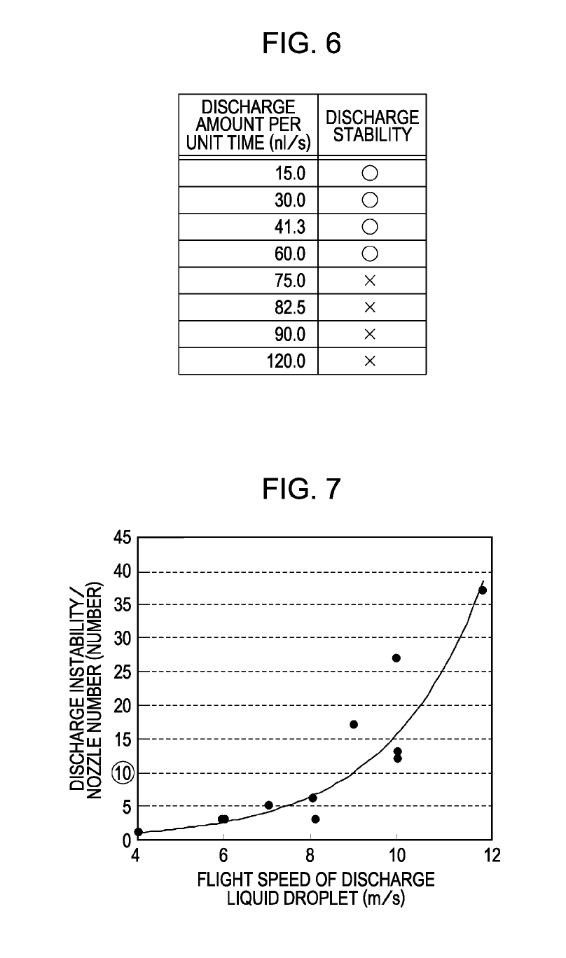

FIG. 6 is a diagram that shows a correlation between an amount of discharge (ejection) of the ink per unit time and discharge stability. For example, FIG. 6 is obtained by changing the drive frequency of the piezoelectric element 20 while maintaining the amount of ink ejected from the nozzle 28 to a constant amount and watching an impact of the ink on each drive frequency, in one pass that performs an outward movement of the carriage 4 in the main scanning direction. Herein, a symbol × of FIG. 6 is a drive frequency condition in which the impacted ink is unstable (a deviation of an impact position, a curve, a dot omission, a deformation of an impact shape or the like), and a symbol ◯ in FIG. 6 is a frequency condition in which the impacted ink is not unstable. Furthermore, the drive frequency sequentially increases from the top to the bottom of the table. As shown in FIG. 6, it is understood that the impact is stable when the volume of the ink ejected from the nozzle 28 per a unit time is equal to or less than 60 nl/s (for example, when the volume of the ink ejected by one ejection from one nozzle 28 is substantially 7 pl, the drive frequency is substantially equal to or less than 8.6 kHz).

Furthermore, FIG. 7 shows a graph that illustrates a correlation between the flight speed (the initial speed) of the ink ejected from the nozzle 28 and the number of the nozzles 28 (the ejection-unstable nozzle) in which the impacted ink is unstable. In FIG. 7, by continuously ejecting the ink at a fixed drive frequency (for example, 1 kHz) for a fixed time (for example, 30 seconds) while changing the flight speed of the ink, the number of the discharge-unstable nozzles is counted. In addition, a circular point shown in the graph is an actual measurement value, and a solid line shows an approximate curve. As shown in the graph, it is understood that, when the flight speed of the ink ejected from the nozzle 28 increases, the number of the discharge-unstable nozzles increases. Since the stable printing under the condition in the range, in which the number of the discharge-unstable nozzles shown in FIG. 7 does not exceed 10, is confirmed from the printing stability evaluation in the evaluation using an actual printer, there is a need to set the flight speed of the ink to be at least 9 m/s or less from the approximate curve so that instability of the impact is 10 or less. However, as will be understood from the graph, since the number of the discharge-unstable nozzle is irregular, it is preferable to set the flight speed of the ink ejected from the nozzle 28 to be 8 m/s or less while keeping some margins. In addition, the flight speed of the ink can be changed, by changing the minimum electric potential Vmin or the maximum electric potential Vmax of the ejection drive pulse DP or both of them. Furthermore, the flight speed of the ink can be changed by changing the slope of the contraction element dp3.

In this manner, since the volume of the ink ejected from the nozzle 28 per unit time is set to be 60 m/s or less and the initial speed of the ink ejected from the nozzle 28 is set to be 8 m/s or less, the ejection characteristics of the ink of each time when continuously ejecting the ink can be matched, and thus the ink can be stably ejected. Thereby, the recording quality of the recording paper 5 can be improved. Furthermore, since the ejection characteristics can be controlled by the drive frequency and the drive voltage, the stable ejection of the ink can be easily performed.

However, in the above-mentioned embodiment, although a so-called bending vibration type piezoelectric element 20 was described as the pressure generating unit, for example, it is also possible to adopt a so-called longitudinal vibration type piezoelectric element, without being limited thereto. In addition, as the pressure generating unit, it is possible to apply the invention to a configuration that adopts the pressure generating unit such as a heating element that causes the pressure fluctuation by bumping the ink by the heat generation, and an electrostatic actuator that causes the pressure fluctuation by displacing the partition wall of the pressure chamber by electrostatic force.

Moreover, if any liquid ejecting apparatus is able to control the ejection of the liquid using the pressure generating unit, the invention can also be applied to a liquid ejecting head that is used for various ink jet type recording apparatuses such as a plotter, a facsimile unit and a copier, a liquid ejecting apparatus other than the recording apparatus, for example, a display manufacturing apparatus, an electrode manufacturing apparatus, a chip manufacturing apparatus or the like, without being limited to the printer. Moreover, in the display manufacturing apparatus, the solutions of each color material of R (Red), G (Green), and B (Blue) are ejected from the color material ejecting head. Furthermore, in the electrode manufacturing apparatus, a liquefied electrode material is ejected from the electrode material ejecting head. In the chip manufacturing apparatus, the solution of the biogenic organic matter is ejected from the biogenic organic matter ejecting head.

What is claimed is:

1. A liquid ejecting apparatus comprising:
a liquid ejecting head capable of ejecting a liquid containing solid contents from a nozzle, by a driving pressure generating unit for changing a capacity of a pressure chamber communicating with the nozzle; and
a control unit for controlling the drive of the pressure generating unit,
wherein the control unit drives the pressure generating unit so that a volume of the liquid ejected from the nozzle per a unit time is equal to or less than 60 nl/s, and an initial speed of the liquid ejected from the nozzle is equal to or less than 8 m/s.

2. The liquid ejecting apparatus according to claim 1,
wherein the control unit sets a driving frequency of the pressure generating unit so that the volume of the liquid ejected from the nozzle per a unit time is equal to or less than 60 nl/s, and the control unit drives the pressure generating unit, using the driving voltage that is set so that the initial speed of the liquid ejected from the nozzle is equal to or less than 8 m/s.

3. The liquid ejecting apparatus according to claim 1,
wherein the solid contents are tubular particles that have a particle diameter of 0.5 to 3 μm.

4. A method of controlling a liquid ejecting apparatus that includes a liquid ejecting head capable of ejecting a liquid containing solid contents from a nozzle, by a driving pressure generating unit for changing a capacity of a pressure chamber communicating with the nozzle, the method comprising:
driving the pressure generating unit so that a volume of the liquid ejected from the nozzle per a unit time is equal to or less than 60 nl/s and an initial speed of the liquid ejected from the nozzle is equal to or less than 8 m/s.

5. The method of controlling a liquid ejecting apparatus according to claim 4,
wherein the solid contents are tubular particles that have a particle diameter of 0.5 to 3 μm.
